(19) United States
(12) Patent Application Publication
(10) Pub. No.: US 2011/0173841 A1
(43) Pub. Date: Jul. 21, 2011

(54) Quarter Configuration for Footwear

(76) Inventor: Rodrique McDuff, St-Bruno (CA)

(21) Appl. No.: 12/974,136

(22) Filed: Dec. 21, 2010

Related U.S. Application Data
(60) Provisional application No. 61/288,491, filed on Dec. 21, 2009.

(51) Int. Cl. A43B 7/20; A43B 23/07; B29C 59/02

(52) U.S. Cl. 36/89; 36/55; 264/324

(57) ABSTRACT

A panel for use as quarter panel or quarter liner comprises a panel body formed of various layers of material pressed into a generally flat state. It also comprises a generally uniform outer surface for the panel body, the outer surface being flat in a malleolus region when the panel body is in the flat state. One or more concavities are defined in the inner surface of the panel body in the flat state and positioned in the malleolus region so as to received at least one malleolus of a wearer when the panel body is formed from the flat state into a boot shape. A method for forming a quarter panel or liner of a boot is also provided.

### CROSS-REFERENCE TO RELATED APPLICATION

The present patent application claims priority on U.S. Provisional Application No. 61/288,491, filed on Dec. 21, 2009, and incorporated herein by reference.

### FIELD OF THE APPLICATION

The present application relates to footwear and, more particularly, to a quarter configuration for footwear having protective features, such as work boots, ice-hockey skates, and the like.

### BACKGROUND OF THE ART

It is known to use a variety of materials and components to provide protective features to boots. For instance, many construction sites now require personnel to work with steel-toe boots. As a result, boots are sturdier by having such protective features. The boot of a hockey skate, for example, has a quarter made of a thick and rigid panel, protecting the wearer's feet from the impact of a puck and the sharpness of a blade.

One of the issues with such sturdy quarters is that the resulting boot may be uncomfortable when worn for the first time. An area of discomfort is at the malleoli (i.e., ankle bones), which protrude and thus contact the quarter. Accordingly, boots must often be broken in to be comfortable. However, during the breaking-in period, the boots are hardly usable for a long period, and may even cause injuries such as blisters.

It is known to form some boots to anatomical shapes by heating the quarters. In fitting procedures, boots may be heated, deformed mechanically, or the like, to match the geometry of the foot of the wearer. Needless to say, such processes are not cost-efficient, and highly customized.

### SUMMARY OF THE APPLICATION

It is therefore an aim of the present disclosure to provide a quarter configuration that addresses issues associated with the prior art.

Therefore, in accordance with the present application, there is provided a panel for use as quarter panel or quarter liner comprising a panel body formed of various layers of material pressed into a generally flat state; a generally uniform outer surface for the panel body, the outer surface being flat in a malleolus region when the panel body is in the flat state; and at least one concavity defined in the inner surface of the panel body in the flat state, positioned in the malleolus region so as to receive at least one malleolus of a wearer when the panel body is formed from the flat state into a boot shape.

Further in accordance with the present application, there is provided a method for forming a quarter panel or liner of a boot, comprising: superposing various layers of material; providing a mold with at least one boss; pressing and heating the mold against the various layers of material to laminate the various layers into a flat quarter panel or liner; simultaneously forming a concavity with the at least one boss in the quarter panel or liner; and forming the flat quarter panel or liner into a boot shape with the concavity being in the malleolus region to accommodate a malleolus of a wearer.

### BRIEF DESCRIPTION OF THE DRAWINGS

FIG. 1 is a perspective view of a quarter panel in accordance with the present disclosure, bent into a boot shape;

FIG. 2 is a perspective view of the quarter panel of FIG. 1, flat;

FIG. 3 is an assembly view of the quarter panel, in accordance with another embodiment;

FIG. 4 is a sectional view taken along section line IV-IV of a stamping mold used to form the quarter panel as in FIG. 2;

FIG. 5 is a sectional schematic view illustrating the quarter panel of FIG. 1 with respect to the foot of a wearer; and

FIG. 6 is an assembly view showing the quarter panel of FIG. 1 as used as a liner of a hockey skate.

### DESCRIPTION OF THE PREFERRED EMBODIMENTS

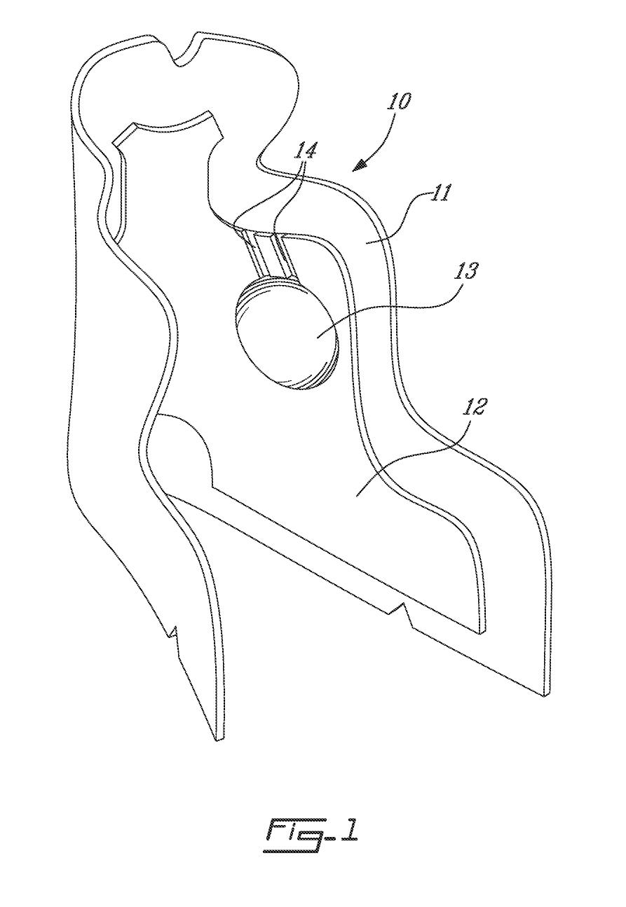

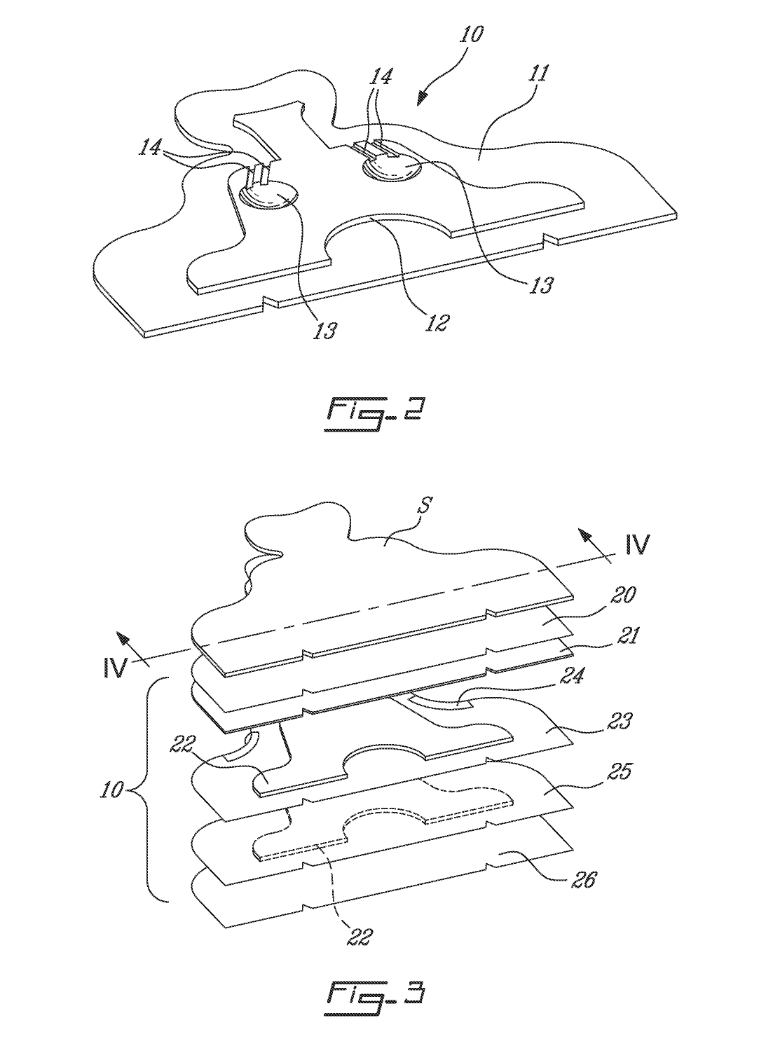

Referring to the drawings, and more particularly to FIGS. 1 and 2, there is illustrated a quarter panel 10 constructed in accordance with an embodiment of the present disclosure. In FIG. 1, the quarter panel 10 is bent into a boot shape. The quarter panel 10 may be used in any type of item of footwear, such as shoes, protective boots, hockey skates, skiing boots, firefighter boots, etc. However, for simplicity, reference will be made hereinafter to boots despite all these possible uses. In FIG. 2, the quarter panel is flat, as obtained for instance at the outlet of a pressing process.

The quarter panel 10 has an inner surface 11. Padding 12 projects forward in the inner surface 11. The padding 12 will contact the foot of the wearer.

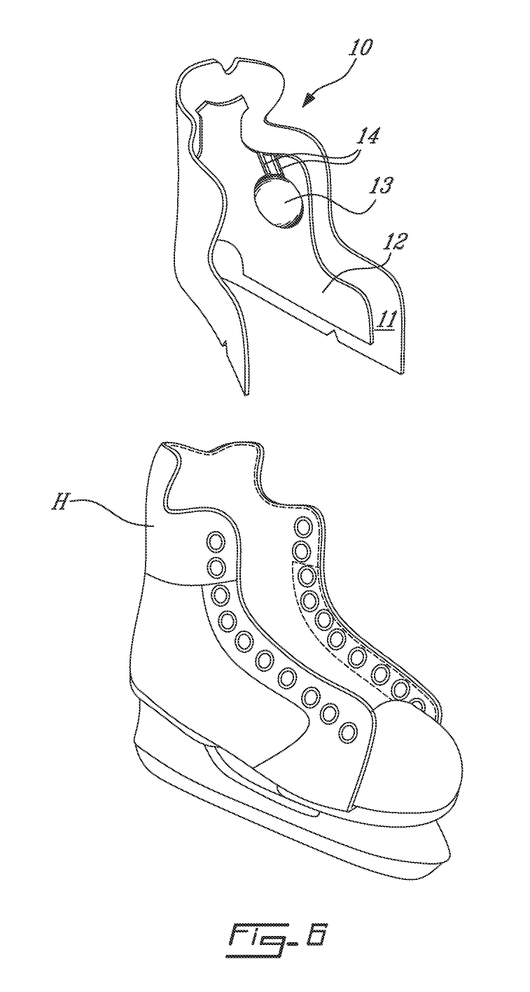

Concavities 13 are defined in the padding 12. The concavities 13 are positioned so as to be opposite the malleoli of the wearer when the boot is worn. As seen in FIG. 5, the concavities 13 are sized to fully accommodate the malleoli M such that the malleoli M do not or minimally contact the quarter panel 10.

Aeration channels 14 are defined in the padding 12. The aeration channels 14 extend from the concavities 13 to the boundary of the padding 12. More specifically, the aeration channels 14 are preferably oriented upwardly with respect to the padding 12. Therefore, air may circulate in and out of the concavities 13 when the boot is worn. Accordingly, moisture may be evacuated through the aeration channels 14. Two of the channels 14 are shown per concavity 13. However, one or more aeration channels 14 may be used as well.

Referring to FIG. 3, an assembly view illustrates various layers that can be used to form the quarter panel 10. A stamping mold S associated with a press will apply pressure on these layers to produce the quarter panel 10 as in FIG. 2. The stamping mold S is typically made of a metal, so as to sustain the forces associated with the pressing process, and so as to transmit heat.

An inner layer 20 forms the exposed inner surface 11 of the quarter panel 10. The inner layer 20 is typically a textile or leather cloth. Examples of materials used as inner layer 20 are polyester, nylon, cotton, leather, synthetic leather, and PVC. Other materials are considered as well.

An adhesive film 21 is then used to laminate the inner layer 20 to a padding component 22 and to a core layer 23. The adhesive film 21 may be a thermally activated adhesive, or a hot-melt adhesive, among many possibilities. In another example, the adhesive film 21 is sprayed onto one of the adjacent layers (e.g., aerosol adhesive).

The padding component 22 generally defines the outlined padding 12 (FIGS. 1 and 2), in the quarter panel 10. The padding component 22 is on the side of the core layer 23 facing the inner layer 20, but may also be on the other side of the core layer 23, as illustrated in dotted lines in FIG. 3. The padding component 22 may consist of a foam or an expanded foam, such as expanded polypropylene (e.g., 2.8 pound/cubic foot, thickness of ⅜ inch). Other foams that may be used are expanded polyethylene, Arcel™, urethane foam, thermoplastic foams or the like.

The core layer 23 may consist of another foam. In an embodiment, the core layer 23 has a smaller density than the padding component 22, to provide a comfort feature to the boot. An example of material for the core layer 23 is thermoplastic polyethylene (e.g., 2.0 pound/cubic foot). Other appropriate types of foams may be used as well.

A reinforcement component 24 may be used where required. For instance, the reinforcement component 24 has an elongated shape as in FIG. 3, to be used on a shoelace edge of the quarter panel 10, in case the quarter panel 10 features eyelets for shoelaces. The reinforcement component 24 increases locally tear resistance to the quarter panel 10. The reinforcement component 24 may be any appropriate material, such as a plastic or a felt.

Another adhesive film 25 is then used to laminate the core layer 23 to the outer layer 26, with the padding component 22 possible between these layers. The adhesive film 25 is similar to the adhesive film 21.

The outer layer 26 forms the outer surface of the quarter panel 10. The nature of the outer layer 26 depends on the contemplated use of the quarter panel 10. If the quarter panel 10 is used as a liner, the outer layer 26 may consist of a simple backing material. The outer layer 26 is a polyester or the like.

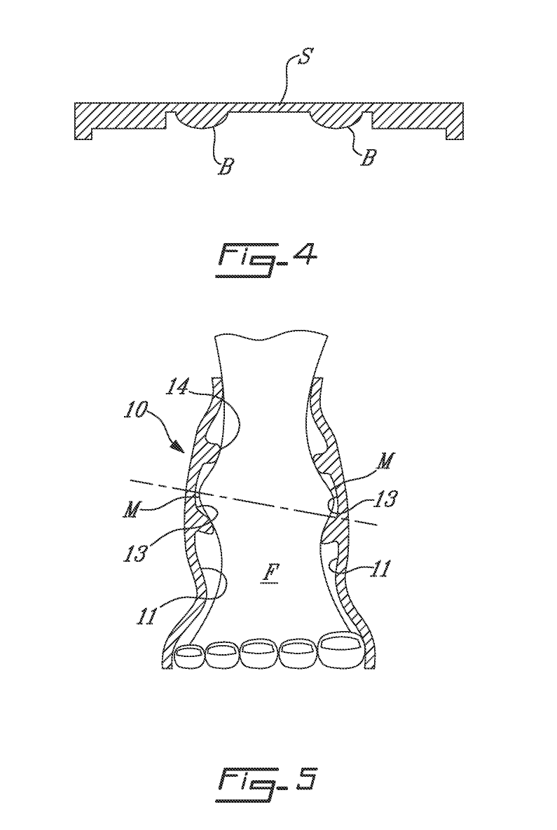

Referring to FIG. 4, a sectional view of the stamping mold S is shown, to illustrate the bosses B (i.e., projection, stamp, etc.) that will form the concavities 13 (FIGS. 1 and 2). During the pressing/lamination process, the combination of heat and pressure will cause the concavities 13 to form into the materials forming the layers of the quarter panel 10. Other protrusions are defined on a same side as the stamping mold S, to form the aeration channels 14 (FIGS. 1 and 2).

Referring to FIG. 5, the quarter panel 10 is shown as a function of the foot F of the wearer. As observed, the concavities 13 may be asymmetrically positioned, to match the geometry of the foot.

Referring to FIG. 6, the quarter panel 10 is shown as used as a liner in a hockey skate H. The core materials of the quarter panel 10 are, as described above, of relatively low density, thereby offering some elasticity/resilience. Accordingly, when used as a liner, the quarter panel 10 acts as an absorbing interface between the boot and the foot of the wearer, all the while separating the malleoli of the wearer from contact with boot material. In other embodiments, the quarter panel 10 also forms the outer quarter shell of the boot, in which case some materials with added rigidity are used.

1. A panel for use as quarter panel or quarter liner comprising:
a panel body formed of various layers of material pressed into a generally flat state;
a generally uniform outer surface for the panel body, the outer surface being flat in a malleolus region when the panel body is in the flat state; and
at least one concavity defined in the inner surface of the panel body in the flat state, positioned in the malleolus region so as to received at least one malleolus of a wearer when the panel body is formed from the flat state into a boot shape.

2. The panel according to claim 1, further comprising at least one aeration channel defined in the inner surface of the panel body in the flat state, the aeration channel extending from the at least one concavity to a periphery of the panel body.

3. The panel according to claim 2, further comprising two of the aeration channel for each of the concavities.

4. The panel according to claim 1, comprising two of the malleolus region, with one of the concavity for each of the malleolus region to receive the malleoli of the wearer.

5. The panel according to claim 1, wherein the panel body comprises a padding layer facing toward the inner surface, and a core layer facing toward the outer surface, with the at least one concavity defined in the padding layer.

6. The panel according to claim 5, wherein the padding layer and the core layer are made of polymers, with the padding layer having a density higher than that of the core layer.

7. The panel according to claim 6, wherein the padding layer is made of expanded polypropylene having a density ranging between 2.3 lb/ft³ and 3.3 lb/ft³.

8. The panel according to claim 6, wherein the core layer is made of thermoplastic polyethylene having a density ranging between 1.5 lb/ft³ and 2.5 lb/ft³.

9. The panel according to claim 5, wherein the panel body comprises a liner layer of cloth or textile forming the inner surface of the panel body, with the padding layer between the liner layer and the core layer.

10. The panel according to claim 9, wherein the liner layer and the core layer share a common outline in the boot shape, while the padding layer has a smaller periphery than the liner layer and core layer to be fully encapsulated therebetween.

11. The panel according to claim 10, further comprising at least one aeration channel defined in the padding layer of the panel body in the flat state, the aeration channel extending from the at least one concavity to a periphery of the padding layer.

12. The panel according to claim 9, further comprising at least one reinforcement component between the liner layer and one of the padding layer and core layer.

13. The panel according to claim 12, wherein the reinforcement component is made of at least one of a plastic and felt.

14. The panel according to claim 12, comprising two of the reinforcement component, with the reinforcement components being located in shoelace eyelet regions of the boot.

15. A method for forming a quarter panel or liner of a boot, comprising:
superposing various layers of material;
providing a mold with at least one boss;
pressing and heating the mold against the various layers of material to laminate the various layers into a flat quarter panel or liner;
simultaneously forming a concavity with the at least one boss in the quarter panel or liner; and
forming the flat quarter panel or liner into a boot shape with the concavity being in the malleolus region to accommodate a malleolus of a wearer.

16. The method according to claim 15, wherein providing a mold comprises providing a mold with two of the boss, and simultaneously forming a concavity comprises simultaneously forming two of the concavity, such that the concavities of the formed boot shape accommodates the malleoli of the wearer.

17. The method according to claim 15, wherein simultaneously forming a concavity with the at least one boss in the quarter panel or liner comprises forming at least one aeration channel in communication with the concavity.
